(19) United States
(12) Patent Application Publication
(10) Pub. No.: US 2021/0134076 A1
(43) Pub. Date: May 6, 2021

(54) INFORMATION PROCESSING APPARATUS, INFORMATION PROCESSING SYSTEM, INFORMATION PROCESSING METHOD, AND INFORMATION PROCESSING PROGRAM

(71) Applicant: Toyota Jidosha Kabushiki Kaisha, Toyota-shi (JP)

(72) Inventors: Shunsuke Tanimori, Nagoya-shi (JP); Ryota Nakabayashi, Toyota-shi (JP); Osamu Izumida, Nagoya-shi (JP); Takeshi Kanou, Seto-shi (JP); Naoki Yamada, Toyota-shi (JP); Kazuyuki Inoue, Nagoya-shi (JP); Shin Sakurada, Toyota-shi (JP); Hiromitsu Fujii, Kariya-shi (JP)

(73) Assignee: Toyota Jidosha Kabushiki Kaisha, Toyota-shi (JP)

(21) Appl. No.: 16/989,001

(22) Filed: Aug. 10, 2020

(30) Foreign Application Priority Data
Nov. 6, 2019 (JP) 2019-201731

(51) Int. Cl. G07C 5/00; G07C 5/08; G01C 21/34

(52) U.S. Cl. CPC G07C 5/006; G01C 21/3492; G01C 21/343; G07C 5/08

(57) ABSTRACT

An information processing apparatus includes a controller communicable with a vehicle. The controller decides a repair point at which the vehicle is repaired based on navigation information of the vehicle in a case where the controller determines that the vehicle needs to be repaired based on the state of the vehicle and notifies the vehicle of the repair point.

### CROSS-REFERENCE TO RELATED APPLICATIONS

This application claims priority to Japanese Patent Application No. 2019-201731 filed on Nov. 6, 2019, which is incorporated herein by reference in its entirety including the specification, drawings and abstract.

### BACKGROUND

### 1. Technical Field

The present disclosure relates to an information processing apparatus, an information processing system, an information processing method, and an information processing program.

### 2. Description of Related Art

In the related art, there is a known system for reception of a request for repair of an automobile. For example, Japanese Unexamined Patent Application Publication No. 2004-302506 (JP 2004-302506 A) discloses a system with which a reply to a request can be made quickly.

### SUMMARY

In a case where arrangements for repair are made after reception of a request for repair, there is a possibility that the arrangements for repair are made late even when repair urgency is high.

The present disclosure provides an information processing apparatus, an information processing system, an information processing method, and an information processing program with which arrangements for repair of a vehicle can be made appropriately.

A first aspect of the present disclosure relates to an information processing apparatus including a controller communicable with a vehicle. The controller decides a repair point at which the vehicle is repaired based on navigation information of the vehicle in a case where the controller determines that the vehicle needs to be repaired based on the state of the vehicle and notifies the vehicle of the repair point.

A second aspect of the present disclosure relates to an information processing system including the information processing apparatus and a notification device. The notification device is configured to notify a driver of the vehicle of the repair point, which the vehicle is notified of by the information processing apparatus, in a case where the vehicle is driven by the driver.

A third aspect of the present disclosure relates to an information processing method. The information processing method includes deciding a repair point at which a vehicle is repaired based on navigation information of the vehicle by a controller communicable with the vehicle in a case where the controller determines that the vehicle needs to be repaired based on the state of the vehicle and notifying the vehicle of the repair point by the controller.

A fourth aspect of the present disclosure relates to an information processing program. The information processing program causes an information processing apparatus communicable with a vehicle to perform an operation including deciding a repair point at which the vehicle is repaired based on navigation information of the vehicle in a case where a determination is made that the vehicle needs to be repaired based on the state of the vehicle, and notifying the vehicle of the repair point.

With the information processing apparatus, the information processing system, the information processing method, and the information processing program according to the aspects of the present disclosure, arrangements for repair of a vehicle can be made appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a configuration example of an information processing system according to an embodiment;

FIG. 2 is a block diagram showing a configuration example of the information processing system according to the embodiment; and

FIG. 3 is a flowchart showing a procedure example of an information processing method according to the embodiment.

### DETAILED DESCRIPTION OF EMBODIMENTS

In a case where a driver of a vehicle notices malfunction of the vehicle, the driver searches for a store where a repairer is present or requests a repairer to perform an on-site service at a safe place to stop the vehicle. In this case, for a person who makes a request for repair, a time taken until an action of a repairer may become long. It is desired that arrangements for repair of a vehicle can be made appropriately corresponding to the state of the vehicle. In addition, for a repairer, the efficiency of a repairing operation may be decreased since the repairer receives a request for repair suddenly. It is desired that a request for repair is appropriately received such that the repairer can make arrangements for repair of a vehicle appropriately.

Configuration Example of Information Processing System 1

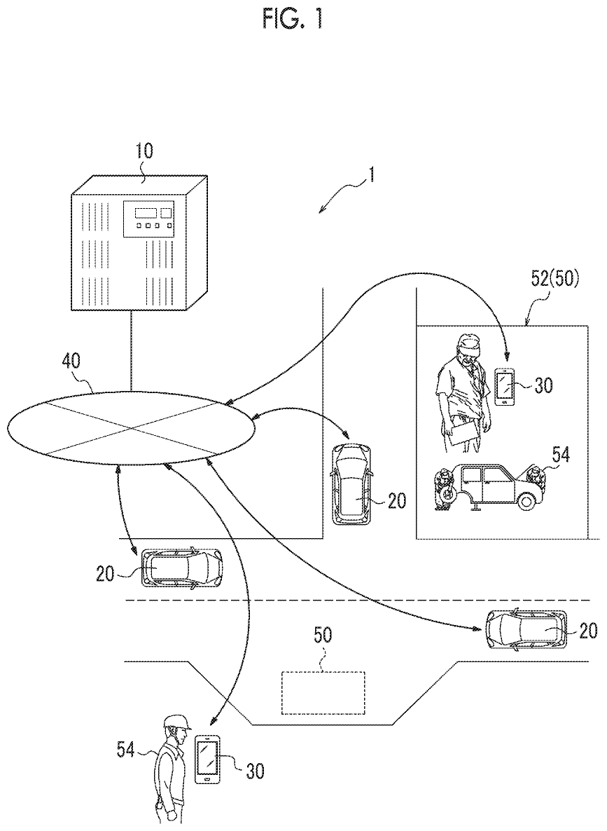

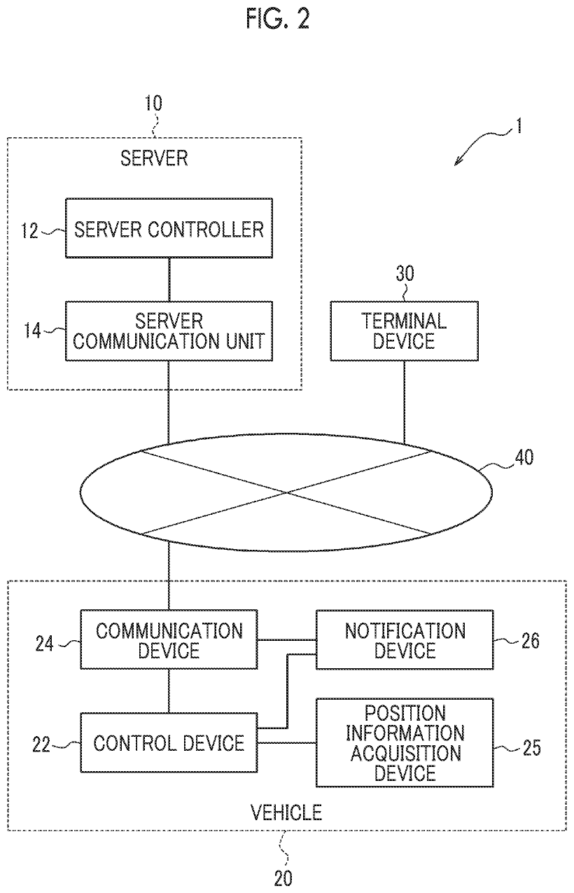

As shown in FIGS. 1 and 2, an information processing system 1 according to an embodiment includes a server 10, a vehicle 20, and a terminal device 30. The server 10, the vehicle 20, and the terminal device 30 are connected to a network 40.

Configuration Example of Server 10

The server 10 is configured to be able to communicate with each of the vehicle 20 and the terminal device 30. The number of servers 10, the number of vehicles 20, and the number of terminal devices 30 are not limited to one and may be two or more. The server 10 will also be referred to as an information processing apparatus. The server 10 may include one server apparatus or a plurality of server apparatuses that can communicate with each other.

The server 10 includes a server controller 12 and a server communication unit 14. The server controller 12 will also be simply referred to as a controller. The server controller 12 may include one or more processors. The “processor” in the present embodiment is a general-purpose processor, a dedicated processor dedicated to a specific process, or the like. However, the processor is not limited thereto. The server controller 12 may include one or more dedicated circuits. The dedicated circuit may include, for example, a field-programmable gate array (FPGA) or an application specific integrated circuit (ASIC). The server controller 12 may include the dedicated circuit instead of the processor and may include the dedicated circuit together with the processor. The server communication unit 14 may include a communication module and may communicate with the vehicle 20 via the network 40. The server 10 may further include a storage unit. The storage unit is a semiconductor memory, a magnetic memory, an optical memory, or the like. However, the storage unit is not limited thereto. The storage unit may function as a main storage device, an auxiliary storage device, or a cache memory. The storage unit may include an electromagnetic storage medium such as a magnetic disk. The storage unit stores any information used to operate the server 10. For example, the storage unit may store a system program, an application program, or the like.

Configuration Example of Vehicle 20

The vehicle 20 includes a control device 22, a communication device 24, and a notification device 26. The control device 22, the communication device 24, and the notification device 26 are connected to each other such that the control device 22, the communication device 24, and the notification device 26 can communicate with each other via a vehicle-mounted network such as a controller area network (CAN) or a dedicated line.

The control device 22 controls each component included in the vehicle 20. The control device 22 may include one or more processors. The control device 22 may include one or more dedicated circuits instead of the processor and may include one or more dedicated circuits together with the processor. The control device 22 may further include a storage unit.

The vehicle 20 may be configured to be able to be operated through autonomous driving. The autonomous driving may be performed at any of levels 1 to 5 defined in the society of automotive engineers (SAE). The definition of the autonomous driving is not limited to that described above and the autonomous driving may be performed based on another definition. In a case where the vehicle 20 is controlled through autonomous driving, the control device 22 controls traveling of the vehicle 20. The server 10 outputs control information, which includes information for specifying the destination of the vehicle 20, to the vehicle 20. The control device 22 controls the traveling of the vehicle 20 based on the control information output by the server 10 and causes the vehicle 20 to move to the destination.

The communication device 24 is connected to the server 10 such that the communication device 24 can communicate with the server 10 via the network 40. The communication device 24 may be, for example, a vehicle-mounted communication device. The communication device 24 may include a communication module connected to the network 40. The communication module may include a communication module conforming to mobile communication standards such as the 4th Generation (4G) and the 5th Generation (5G) and is not limited thereto.

The notification device 26 is connected to another component installed in the vehicle 20 such that the notification device 26 and the component can communicate with each other via a vehicle-mounted network such as a CAN or a dedicated line. The notification device 26 notifies a driver of the vehicle 20 of information. The notification device 26 may display a map based on position information of the vehicle 20. The notification device 26 may generate a scheduled route based on the current position and the destination of the vehicle 20 and may display the route on the map. Information relating to the scheduled route generated by the notification device 26 will also be referred to as route information. The notification device 26 may display a map based on navigation information including the position information and the route information of the vehicle 20. That is, the notification device 26 may also have a function as a car navigation device.

The notification device 26 may notify the driver of information in the form of visual information such as an image, a letter, or a figure. In this case, the notification device 26 may be configured by using a display device. The display device may include a light emitting device such as a light emission diode (LED). The display device may be a liquid crystal display (LCD), for example. The display device may be an organic electro-luminescence (EL) display or an inorganic EL display. The display device may be a plasma display panel (PDP). The display device is not limited to those displays and other various types of displays may also be adopted.

The notification device 26 may notify the driver of information in the form of auditory information such as a voice. In this case, the notification device 26 may be configured by using a device such as a speaker which outputs a voice. The notification device 26 is not limited to the above-described examples and the notification device 26 may be configured by using other various devices.

The vehicle 20 may be driven by the driver instead of being autonomously driven. In this case, the notification device 26 may acquire the information for specifying the destination of the vehicle 20 from the server 10 and notify the driver of the destination of the vehicle 20. The driver drives the vehicle 20 and causes the vehicle 20 to move to the destination which the driver is notified of by the notification device 26.

The vehicle 20 further includes a position information acquisition device 25 which may not be provided. The position information acquisition device 25 is connected to the control device 22 or the communication device 24 such that the position information acquisition device 25 can communicate with the control device 22 or the communication device 24 via a vehicle-mounted network such as a CAN or a dedicated line. The position information acquisition device 25 may be connected to the notification device 26 also such that the position information acquisition device 25 can communicate with the notification device 26. The position information acquisition device 25 acquires position information of the vehicle 20. The position information acquisition device 25 may include a receiver corresponding to a satellite position measurement system. The receiver corresponding to the satellite position measurement system may include a global positioning system (GPS) receiver, for example. The vehicle 20 can acquire the position information of the vehicle 20 by using the position information acquisition device 25. The vehicle 20 may output the position information of the vehicle 20 to the server 10.

Configuration Example of Terminal Device 30

The terminal device 30 may include, for example, a personal computer (PC) such as a desktop PC, a notebook PC, and a tablet PC, or a mobile terminal such as a smartphone. The terminal device 30 is connected to the server 10 in a wired manner or a wireless manner such that the terminal device 30 can communicate with the server 10 via the network 40.

The terminal device 30 acquires, from the server 10, information relating to the vehicle 20 that needs to be repaired and notifies a repairer 54 of the acquired information. The terminal device 30 may include a liquid crystal or organic electro-luminescence (EL) display device, an inorganic EL display device, or the like. The terminal device 30 may be connected to an external display device and may cause the external display device to display information. The repairer 54 makes preparations for repair of the vehicle 20 based on the information displayed on the terminal device 30.

Operation Example of Information Processing Apparatus

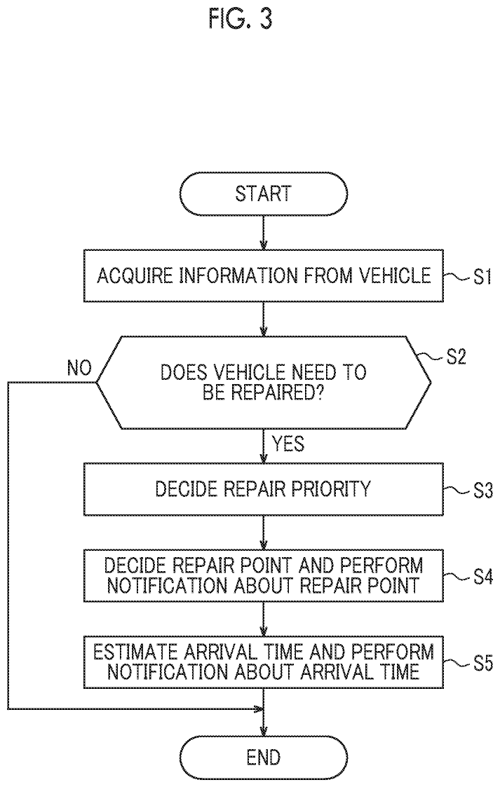

The server controller 12 of the server 10 (information processing apparatus) may perform an information processing method including a procedure as in a flowchart illustrated in FIG. 3, for example. The information processing method may be realized as an information processing program executed by a processor of the server controller 12 or the like. The information processing program may be stored in a non-transitory computer-readable storage medium. A processor of the server controller 12 or the like may read and execute the information processing program stored in the non-transitory computer-readable storage medium.

The server controller 12 acquires information from the vehicle 20 (step S1). The information that the server controller 12 acquires from the vehicle 20 includes navigation information of the vehicle 20 and information relating to the state of the vehicle 20. The navigation information of the vehicle 20 may include at least one of position information and route information of the vehicle 20. The information relating to the state of the vehicle 20 may include, for example, the temperature of an engine. The temperature of the engine may include, for example, the temperature of engine oil or the temperature of engine coolant. The information relating to the state of the vehicle 20 may include, for example, the degree of acceleration acting on the vehicle 20. The degree of acceleration may include components in a lateral direction or a vertical direction of the vehicle 20 in addition to components in a direction in which the vehicle 20 proceeds.

The server controller 12 determines whether or not the vehicle 20 needs to be repaired (step S2). The server controller 12 may determine whether or not the vehicle 20 needs to be repaired based on the information relating to the state of the vehicle 20. The server controller 12 may determine that the vehicle 20 needs to be repaired based on the degree of acceleration acting on the vehicle 20 in a case where the amplitude of vibration that is generated while the vehicle 20 is traveling is equal to or greater than a predetermined value, for example. The server controller 12 may determine that the vehicle 20 needs to be repaired in a case where the temperature of the engine of the vehicle 20 is equal to or greater than a predetermined temperature, for example. The server controller 12 is not limited to the above examples and the server controller 12 may determine whether or not the vehicle 20 needs to be repaired based on various kinds of information included in the information relating to the state of the vehicle 20.

The server controller 12 may determine whether the vehicle 20 needs to be repaired based further on the navigation information of the vehicle 20.

The server controller 12 may determine whether or not the vehicle 20 needs to be repaired based on the route information of the vehicle 20. The server controller 12 may determine whether the vehicle 20 is to travel along a route at which a large load is applied to an engine like a road at which the vehicle 20 travels up and down a large number of times and may determine whether the vehicle 20 needs to be repaired based on the result of route determination and the temperature of the engine. The server controller 12 may determine whether or not the vehicle 20 is to travel along a route at which traveling of the vehicle is likely to cause vibration like an unpaved road and may determine whether or not the vehicle 20 needs to be repaired based on the result of route determination and the degree of acceleration acting on the vehicle 20. The server controller 12 may change a threshold value for determination on whether or not the vehicle 20 needs to be repaired based on the result of route determination. For example, the server controller 12 may increase a threshold value relating to the temperature of the engine in a case where the server controller 12 determines that the vehicle 20 is to travel along a road at which the vehicle 20 travels up and down a large number of times. For example, the server controller 12 may increase a threshold value relating to the degree of acceleration acting on the vehicle 20 in a case where the server controller 12 determines that the vehicle 20 is to travel along an unpaved road.

The server controller 12 may determine whether or not the vehicle 20 needs to be repaired based on the position information of the vehicle 20. The server controller 12 may change a threshold value for determination on whether or not the vehicle 20 needs to be repaired based on whether or not the vehicle 20 is at an urban area. The server controller 12 may change a threshold value for determination on whether or not the vehicle 20 needs to be repaired based on the altitude of the vehicle 20.

The server controller 12 is not limited those examples and may determine whether the vehicle 20 needs to be repaired based on various kinds of information included in the navigation information of the vehicle 20.

In a case where the server controller 12 determines that the vehicle 20 does not need to be repaired (NO in step S2), the server controller 12 terminates the procedure as in the flowchart shown in FIG. 3.

In a case where the server controller 12 determines that the vehicle 20 needs to be repaired (YES in step S2), the server controller 12 decides the repair priority thereof (step S3). The server controller 12 may estimate a distance by which the vehicle 20 can travel without being repaired and the shorter the estimated distance by which vehicle 20 can travel without being repaired, the higher the repair priority of the vehicle 20 may be.

The server controller 12 decides a point at which the vehicle 20 is to be repaired and notifies the vehicle 20 of the point (step S4). The point at which the vehicle 20 is to be repaired will be also referred to as a repair point 50. The server controller 12 decides the repair point 50 based on the navigation information of the vehicle 20.

The server controller 12 may decide the repair point 50 based on the route information of the vehicle 20. In a case where a repair shop 52 is on the scheduled route of the vehicle 20, the server controller 12 may decide the repair shop 52 as the repair point 50. In a case where the repair shop 52 is not on the scheduled route of the vehicle 20, the server controller 12 may decide the repair shop 52 not on the scheduled route as the repair point 50. The server controller 12 may decide, as the repair point 50, the repair shop 52 that is closest to the current position of the vehicle 20 from among the repair shops 52 not on the scheduled route. The server controller 12 may decide, as the repair point 50, the repair shop 52 that is separated from the scheduled route by the shortest distance from among the repair shops 52 not on the scheduled route.

The server controller 12 may decide the repair point 50 based on the position information of the vehicle 20. The server controller 12 may decide, as the repair point 50, the repair shop 52 that is closest to the current position of the vehicle 20 regardless of the scheduled route of the vehicle 20. The server controller 12 may select one of the repair shops 52 that are positioned within a predetermined distance from the current position of the vehicle 20 and may decide the one of the repair shops 52 as the repair point 50. The server controller 12 may select the one of the repair shops 52 that are positioned within the predetermined distance from the current position of the vehicle 20 based on the scheduled route of the vehicle 20.

In a case where a point at which the vehicle 20 can be parked or stopped is on the scheduled route of the vehicle 20, the server controller 12 may decide the point as the repair point 50. The server controller 12 may decide a point, at which the repairer 54 can perform repair of the vehicle 20, as the repair point 50.

The server controller 12 may decide the repair point 50 based on the state of the vehicle 20. In a case where the vehicle 20 needs to be repaired but there is no problem even when the vehicle 20 travels for a while or in a case where the repair priority of the vehicle 20 is low, the server controller 12 may appropriately select the repair shop 52 and decide the repair shop 52 as the repair point 50 regardless of a distance from the current position. The server controller 12 may decide, as the repair point 50, the repair shop 52 at which the vehicle 20 can be repaired after a short wait after arrival at the repair shop 52. The server controller 12 may decide, as the repair point 50, the repair shop 52 positioned on the scheduled route. The server controller 12 may decide, as the repair point 50, the repair shop 52 that is separated from the scheduled route by the shortest distance. In a case where the vehicle 20 needs to be repaired soon or in a case where the repair priority of the vehicle 20 is high, the server controller 12 may decide, as the repair point 50, the repair shop 52 or a vehicle parking and stopping point closest to the current position.

The server controller 12 notifies the vehicle 20 of the decided repair point 50. In a case where the driver drives the vehicle 20, the notification device 26 notifies the driver of the vehicle 20 of the repair point 50 which the vehicle 20 is notified of. The notification device 26 may notify the driver of the repair point 50 by displaying the repair point 50 on a map. The notification device 26 may notify the driver of the repair point 50 by displaying the scheduled route of the vehicle 20 changed to a route including the repair point 50. In a case where the vehicle 20 travels while being autonomously driven, the control device 22 causes the vehicle 20 to travel based on the repair point 50 which the vehicle 20 is notified of and causes the vehicle 20 to be parked or stopped at the repair point 50.

The server controller 12 may notify the terminal device 30 of the repair point 50, the terminal device 30 being owned by the repairer 54. In a case where the repair shop 52 is decided as the repair point 50, the server controller 12 may notify the terminal device 30 that the vehicle 20 to be repaired will enter the repair shop 52, the terminal device 30 being owned by the repairer 54 who performs repair at the repair shop 52. The server controller 12 may decide the turn for the vehicle 20 entering the repair shop 52 to be repaired based on the repair priority of the vehicle 20 and notify the terminal device 30 of the turn for the vehicle 20 to be repaired.

In a case where the server controller 12 decides a point other than the repair shop 52 as the repair point 50, the server controller 12 may notify the terminal device 30 of the repair point 50, the terminal device 30 being owned by the repairer 54 who can visit the point and perform repair. The terminal device 30 may notify the repairer 54 of the repair point 50 by displaying the repair point 50 on a map.

The server controller 12 may notify the terminal devices 30 of the repair point 50, the terminal devices 30 being owned by a plurality of the repairers 54 respectively. The server controller 12 may acquire a reply indicating whether to undertake repair of the vehicle 20 from the repairer 54 who receives notification about the repair point 50. The server controller 12 may decide which repairer 54 is to be in charge of repair of the vehicle 20 based on the reply of the repairer 54. The server controller 12 may decide the order in which the repairer 54 visits a plurality of the repair points 50 based on the repair priorities of the vehicles 20. The server controller 12 may notify the terminal device 30 of the repairer 54 of the decided order. The server controller 12 may decide the order in which the repairers 54 visit the repair points 50. In this case, the server controller 12 may notify the terminal device 30 of the repair point 50 having the highest priority, the terminal device 30 being owned by the repairer 54 who is not busy. The server controller 12 may decide the order in which one repairer 54 or one group of repairers 54 visits the repair points 50.

The server controller 12 estimates a time of arrival at the repair point 50 of the vehicle 20 and notifies the terminal device 30 of the repairer 54 of the estimated time (step S5). The estimated time of arrival will be also referred to as an estimated arrival time. The server controller 12 may estimate the time of arrival based on the current position of the vehicle 20 and the repair point 50. In a case where the repair point 50 is the repair shop 52, the repairer 54 waits at the repair shop 52 until the vehicle 20 enters the repair shop 52. The repairer 54 may prepare for a repairing operation in advance based on the state of the vehicle 20. In a case where the repair point 50 is a point outside the repair shop 52, the repairer 54 may prepare for a repairing operation or may start to move to the repair point 50 to arrive at the repair point 50 in accordance with the estimated arrival time. After the procedure in step S5, the server controller 12 may terminate the information processing method as in the flowchart shown in FIG. 3.

As described above, with the information processing system 1, the information processing apparatus (server 10), the information processing method, and the information processing program according to the present embodiment, arrangements for repair can be made corresponding to the necessity of repair of the vehicle 20. As a result, arrangements for repair of the vehicle 20 can be made appropriately.

In the present embodiment, since the repair priority is decided, arrangements for repair can be made corresponding to repair urgency of the vehicle 20. As a result, arrangements for repair of the vehicle 20 can be made appropriately.

In the present embodiment, the order in which vehicles enter the repair shop 52 or the order in which the repairer 54 visits the repair points 50 is decided based on repair priorities. As a result, repair can be appropriately started corresponding to repair urgency of the vehicle 20.

In the present embodiment, the repairer 54 can prepare for repair of the vehicle 20 based on an estimated arrival time. As a result, repair of the vehicle 20 can be performed efficiently.

The embodiment of the present disclosure has been described based on the drawings and examples. However, it should be noted that various changes or modifications can be easily made by those skilled in the art based on the present disclosure. Accordingly, those changes or modifications should be construed as being included within the scope of the present disclosure. For example, the functions or the like included in each element or each step can be rearranged without logical inconsistency, and a plurality of elements or steps can be combined with each other or be divided.

What is claimed is:

1. An information processing apparatus comprising a controller communicable with a vehicle,
wherein the controller is configured to decide a repair point at which the vehicle is repaired based on navigation information of the vehicle in a case where the controller determines that the vehicle needs to be repaired based on a state of the vehicle and notify the vehicle of the repair point.

2. The information processing apparatus according to claim 1, wherein the controller decides a repair priority of the vehicle based on the state of the vehicle.

3. The information processing apparatus according to claim 2, wherein the controller decides the repair priority of the vehicle based further on a distance from a current position of the vehicle to the repair point.

4. The information processing apparatus according to claim 2, wherein the controller decides a store of a repairer as the repair point and decides a turn for the vehicle entering the store of the repairer to be repaired based on the repair priority.

5. The information processing apparatus according to claim 2, wherein the controller decides an order in which a repairer visits the repair points based on the repair priorities.

6. The information processing apparatus according to claim 1, wherein the controller decides a store of a repairer as the repair point.

7. The information processing apparatus according to claim 4, wherein the controller estimates a time of arrival at the repair point of the vehicle and notifies a terminal device of the time of arrival, the terminal device being owned by the repairer.

8. The information processing apparatus according to claim 1, wherein the state of the vehicle includes a degree of acceleration of the vehicle.

9. The information processing apparatus according to claim 1, wherein the navigation information includes at least one of position information and route information of the vehicle.

10. An information processing system comprising:
the information processing apparatus according to claim 1; and
a notification device configured to notify a driver of the vehicle of the repair point, which the vehicle is notified of by the information processing apparatus, in a case where the vehicle is driven by the driver.

11. An information processing method comprising:
deciding a repair point at which a vehicle is repaired based on navigation information of the vehicle by a controller communicable with the vehicle in a case where the controller determines that the vehicle needs to be repaired based on a state of the vehicle; and
notifying the vehicle of the repair point by the controller.

12. The information processing method according to claim 11, further comprising deciding a repair priority of the vehicle based on the state of the vehicle by the controller.

13. The information processing method according to claim 12, further comprising deciding the repair priority of the vehicle based further on a distance from a current position of the vehicle to the repair point by the controller.

14. The information processing method according to claim 12, further comprising:
deciding a store of a repairer as the repair point by the controller; and
deciding a turn for the vehicle entering the store of the repairer to be repaired based on the repair priority by the controller.

15. The information processing method according to claim 12, further comprising deciding an order in which a repairer visits the repair points based on the repair priorities by the controller.

16. The information processing method according to claim 11, further comprising deciding a store of a repairer as the repair point by the controller.

17. The information processing method according to claims 14, further comprising:
estimating a time of arrival at the repair point of the vehicle by the controller; and
notifying a terminal device of the time of arrival by the controller, the terminal device being owned by the repairer.

18. A non-transitory storage medium storing instructions that are executable by an information processing program causing an information processing apparatus communicable with a vehicle causing the information processing apparatus to perform an operation including
deciding a repair point at which the vehicle is repaired based on navigation information of the vehicle in a case where a determination is made that the vehicle needs to be repaired based on a state of the vehicle, and
notifying the vehicle of the repair point.

19. The information processing program according to claim 18, wherein the operation further includes deciding a repair priority of the vehicle based on the state of the vehicle.

20. The information processing program according to claim 18, wherein the operation further includes deciding a store of a repairer as the repair point.
